(19) United States
(12) Patent Application Publication
(10) Pub. No.: US 2025/0258974 A1
(43) Pub. Date: Aug. 14, 2025

(54) DATA CENTRE COOLING OPTIMISATION

(71) Applicant: EKKOSENSE LTD., Lincoln Lincolnshire (GB)

(72) Inventors: Paul MILBURN, Nottingham (GB); Anuraag SAXENA, Nottingham (GB); Stuart REDSHAW, Loughborough (GB)

(21) Appl. No.: 19/111,430

(22) PCT Filed: Sep. 15, 2023
(86) PCT No.: PCT/GB2023/052391

§ 371 Date: Mar. 13, 2025

(30) Foreign Application Priority Data
Sep. 15, 2022 (GB) 2213517.2

(51) Int. Cl. G06F 30/20; G06F 30/13; G06F 113/02; G06F 119/08

(52) U.S. Cl. CPC G06F 30/20; G06F 30/13; G06F 2113/02; G06F 2119/08

(57) ABSTRACT

A computer-implemented method for identifying modifications in a data center to optimize airflow and cooling. The method includes: i) providing a model of the data centre represented as a grid having a plurality of cells, each cell having an object identifier selected from a plurality of objects including a floor tile, an open vent and an equipment rack; ii) assigning a score to each cell and to adjacent cells based on the cell's object identifier; iii) calculating a total score for each cell having a floor tile or open vent object identifier; iv) identifying whether a cell having an open vent object identifier has a total score below a lower score threshold; v) identifying whether a cell having a floor tile object identifier has a score above an upper score threshold; and vi) providing a visual output indicating any identified cells together with a recommendation for cells to be changed.

### FIELD OF THE INVENTION

The invention relates to a computer-implemented method for identifying modifications in a data centre to optimise airflow and cooling.

### BACKGROUND

Data centres require cooling to maintain equipment racks within a desired temperature range. Overheating of equipment can result in failure or reduced lifetimes, while overcooling results in excessive energy usage. It is therefore important to be able to optimise cooling within a data centre, which may be done by adjusting how airflow is provided. Cooling airflow within a typical data centre is provided from one or more air handling units (AHUs) that provide a flow of cooling air to equipment racks via underfloor passages and floor vents, heated air being extracted via overhead outlets. A typical data centre is arranged such that floor tiles can be either blank or contain a vent. Vents may be adjustable to provide a selected degree of airflow to an adjacent equipment rack.

A problem with existing data centre cooling, particularly for larger data centres containing many equipment racks and multiple AHUs, is that optimising cooling can be a complex task. Making adjustments to one area of the data centre can affect how other areas operate, due to opening and closing vents changing a distribution of airflow throughout the data centre and consequently changing operating temperatures of equipment racks. Simply adding more vents next to equipment racks showing high temperatures will tend to result in non-optimised cooling. It is an object of the present invention to address this problem.

### SUMMARY OF THE INVENTION

In accordance with a first aspect of the invention there is provided a computer-implemented method for identifying modifications in a data centre to optimise air flow cooling, the method comprising:
i) providing a model of the data centre represented as a grid comprising a plurality of cells, each cell having an object identifier, the object identifier selected from a plurality of objects including a floor tile, an open vent and an equipment rack;
ii) assigning a score to each cell and to cells adjacent to each cell based on the cell's object identifier;
iii) calculating a total score for each cell having a floor tile or open vent object identifier;
iv) identifying whether a cell having an open vent object identifier has a total score below a lower score threshold;
v) identifying whether a cell having a floor tile object identifier has a score above an upper score threshold; and
vi) providing as a visual output to a user of the model an indication on the grid of any cells identified in steps iv) and v) together with a recommendation for cells to be changed.

By assigning scores to cells throughout the grid, airflow cooling can be optimised in a sequential process through identifying cells where changes can be made, either to improve airflow through providing an open vent where required, or to improve efficiency of the airflow cooling by removing or closing open vents that are not required. As a result, operation of airflow cooling of the data centre can be optimised, resulting in energy savings and maintaining reliable operation of equipment.

The recommendation for a cell identified in step iv) may be for the open vent to be changed by removing or closing the open vent. The recommendation for a cell identified in step v) may be for the floor tile to be changed to an open vent. Vents that are removed may be reused by placing them where they are calculated to be more effective.

The method may further comprise:
vii) receiving a user input amending the object identifier of one or more cells identified in steps iv) or v). The user, having followed one or more recommendations, will need to update the model to indicate the change being made so that the model can provide further optimising recommendations.

The method may comprise repeating steps ii) to vi). Iterating the model results in a sequential series of optimising rounds.

The method may further comprise, prior to repeating steps ii) to vi), receiving a user input rejecting a recommendation relating to a cell and updating the model to exclude the cell from being identified when repeating steps ii) to vi). This enables a user to mark a particular cell as not being changed, for example if a vent is fixed and cannot be changed or if a vent cannot be placed in a particular location. The model can then proceed to further without making any further recommendations for that cell.

The method may further comprise repeating steps ii) to vii) until all cells have a score between the upper and lower score thresholds. The end result of this is an optimised airflow cooling for the data centre, at least to a first approximation.

Cells adjacent to each cell may include cells laterally adjacent and diagonally adjacent to each cell. An open vent cell will affect airflows in cells immediately adjacent, which may be represented by applying scores to cells laterally adjacent. An active equipment rack cell will affect a cell immediately adjacent a front of the rack, but also to cells on either side of the front of the rack, which will be diagonally adjacent the rack cell.

Each cell having an equipment rack object identifier may have an orientation indicating an air inlet side of the equipment rack. Step ii) of the method may include assigning a positive score to a cell adjacent the air inlet side. Step ii) may include assigning a smaller positive score to cells diagonally adjacent the air inlet side.

For each cell having an open vent object identifier, step ii) may include assigning a negative score to the cell and a smaller negative score to laterally adjacent cells.

Steps iv) and v) may exclude any cells adjacent to an identified cell from being identified. This prevents excessive changes being recommended over a round of implementing the method. Steps iv) and v) may for example be carried out on alternate cells in the grid.

Calculating the total score for each cell may comprise adding a score for the cell to a score for the cell provided by adjacent cells.

Each cell having an equipment rack object identifier may have an associated recorded temperature. Once the first approximation of optimisation is carried out, the recorded temperatures can be used with scores between the upper and lower score limits to further optimise.

The method may further comprise:
viii) identifying whether a cell having a floor tile object identifier has a score between the upper and lower score thresholds and whether an adjacent cell having an equipment rack has an associated recorded temperature above an upper threshold temperature; and
ix) providing as a visual output to a user of the model an indication on the grid of any cells identified in step viii) together with a recommendation to open or add a vent at each identified cell.

The method may further comprise:
x) identifying whether a cell having a floor tile object identifier has a score between the upper and lower score thresholds and whether an adjacent cell having an equipment rack has an associated recorded temperature below an lower threshold temperature; and
xi) providing as a visual output to a user of the model an indication on the grid of any cells identified in step x) together with a recommendation to close or remove a vent at each identified cell.

According to a second aspect there is provided a computer program comprising instructions that, when executed, cause a computer to perform the method according to the first aspect. The computer program may for example be stored on a non-transitory computer-readable medium.

### DETAILED DESCRIPTION

The invention is described in further detail below by way of example and with reference to the accompanying drawings, in which:

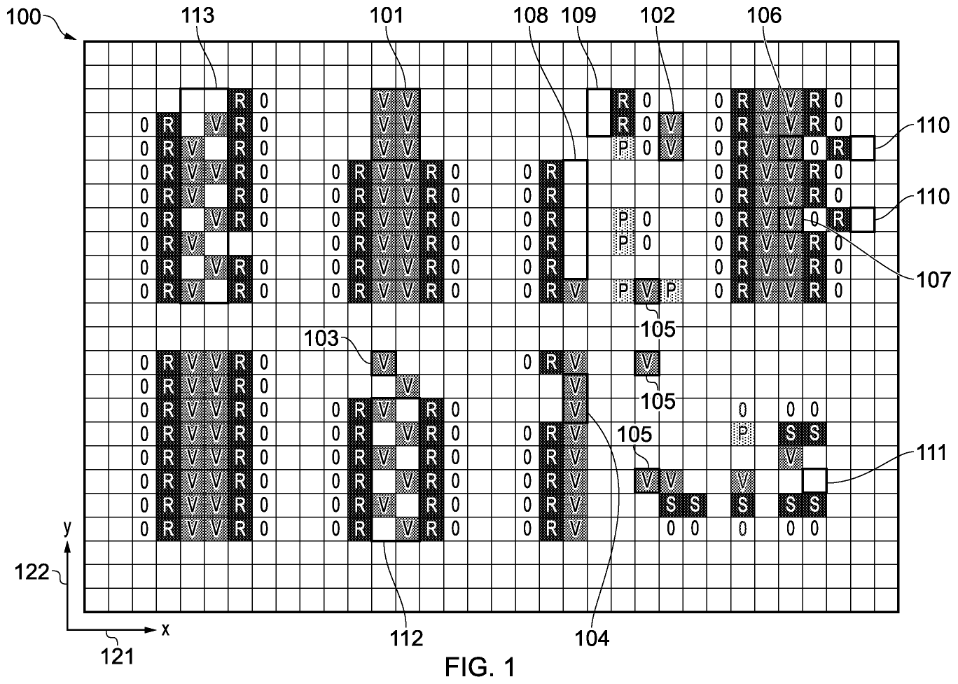

FIG. 1 is a representation of a data centre as a grid comprising a plurality of cells with identifiers;

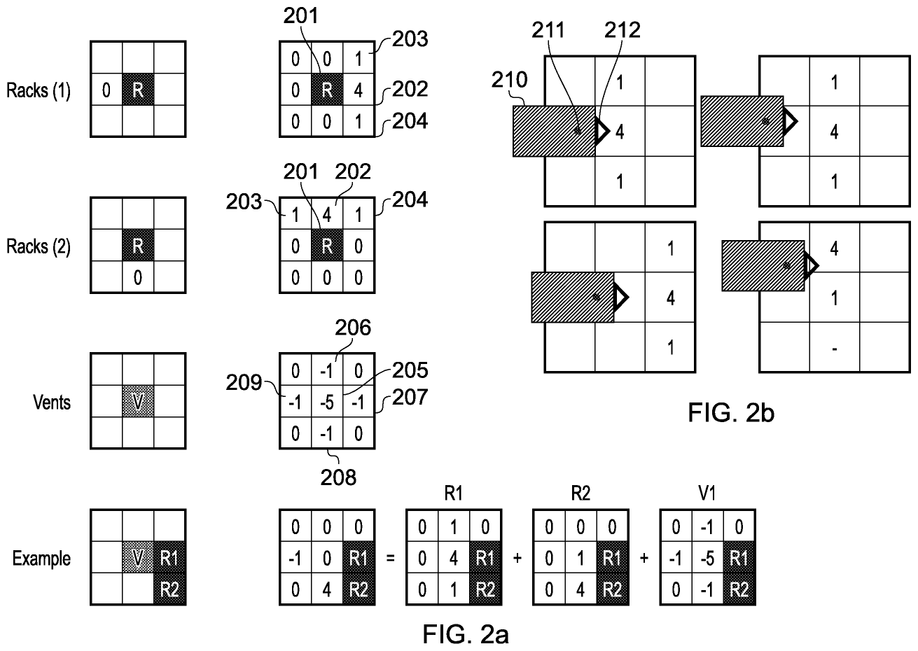

FIG. 2a is a schematic representation of cell identifiers and corresponding cell scores;

FIG. 2b is a schematic representation of a position of an equipment rack on a grid;

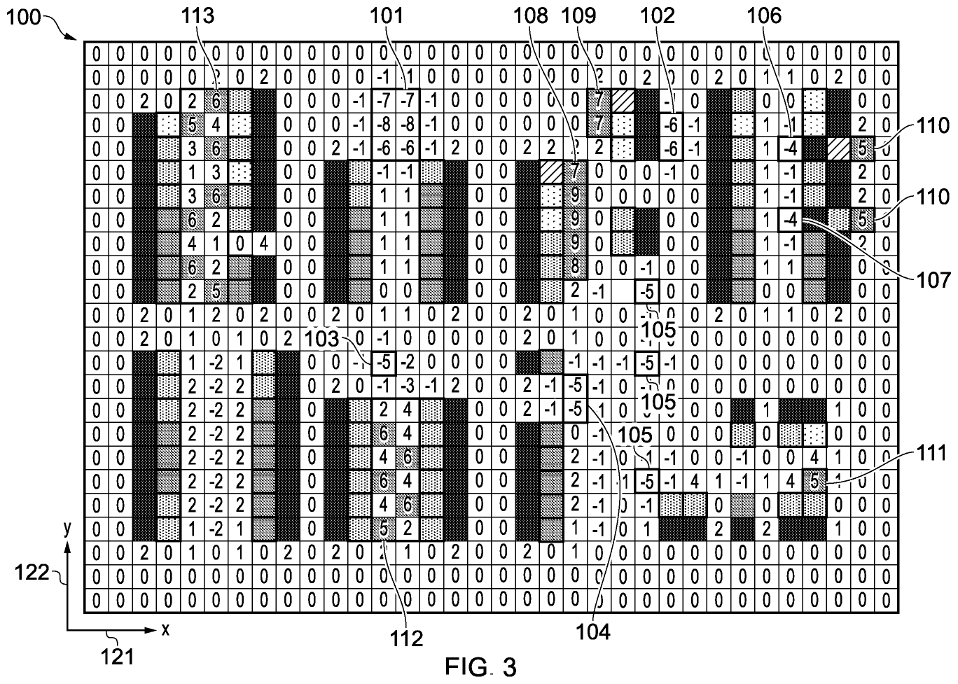

FIG. 3 is the representation of FIG. 1 with example cell scores included;

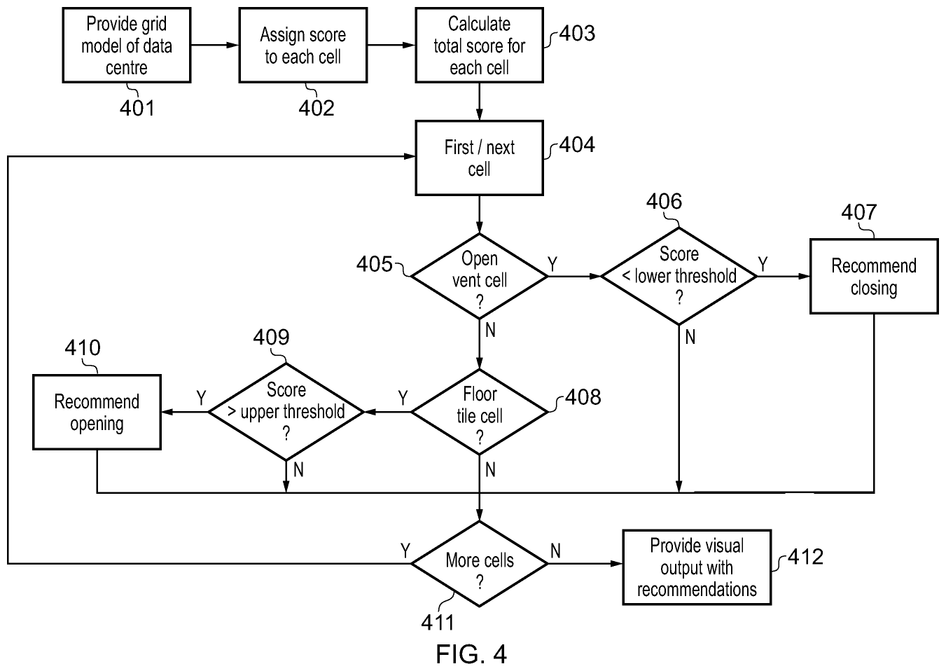

FIG. 4 is a schematic flow diagram illustrating an example method of optimising airflow cooling;

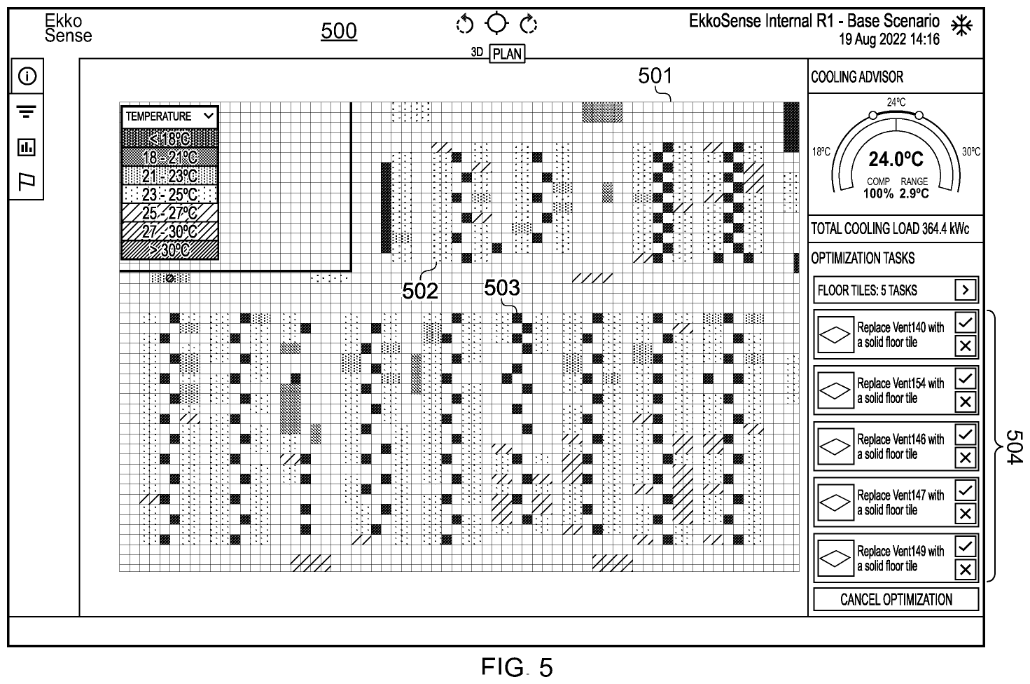

FIGS. 5, 6 and 7 are screenshots of an example graphical user interface (GUI) with recommendations for action by a user;

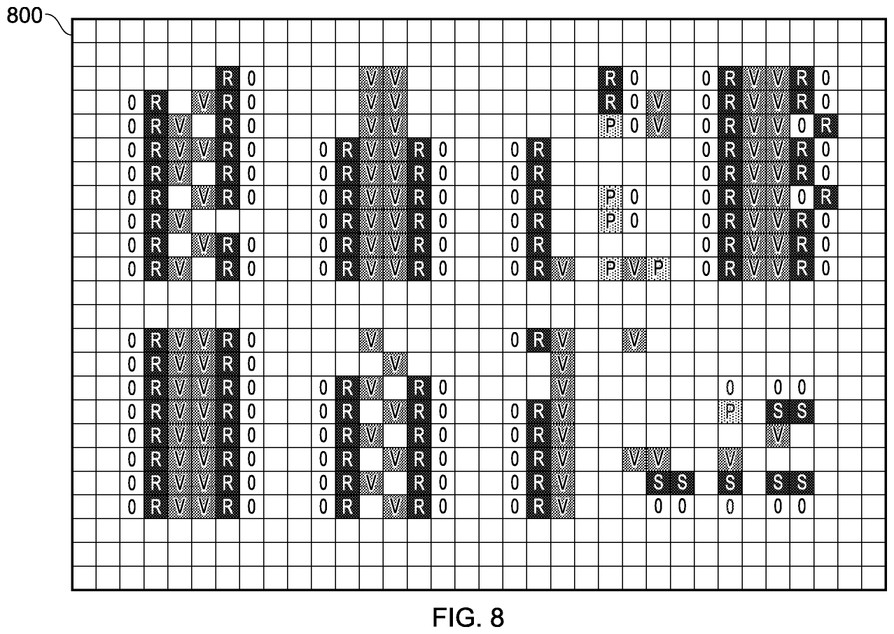

FIGS. 8 to 17 are grid representations of an example data centre illustrating an example sequence of operations for optimising airflow cooling;

FIG. 1 illustrates a representation of a data centre in the form of a grid 100 comprising a plurality of cells. The grid 100 is in the form of a rectangular grid, which is typical for a data centre having rows of equipment racks separated by passages. The grid does not need to be an accurately scaled representation of the data centre itself, but represents the relative position and layout of objects in the data centre. The grid 100 is aligned along orthogonal x and y axes 121, 122, which define lateral directions in the grid 100. References herein to laterally adjacent cells therefore relate to cells that are adjacent in the x or y directions, while references to diagonally adjacent cells relate to cells that are at 45 degrees to the x or y directions.

Each cell in the grid 100 has an object identifier, which indicates what type of object is present at that position. Each object may also have a rating. The object identifier indicates whether the cell represents an object such as a floor tile, vent, equipment rack or outlet. In the illustrated example, the object identifiers include those in Table 1 below.

TABLE 1
Object identifiers

| Object identifier | Representation |
|---|---|
| R, S | Equipment rack - active |
| | (R = east/west or x-axis orientation, |
| | S = north/south orientation or y-axis |
| | orientation) |
| P | Equipment rack - passive |
| V | Open floor vent |
| C | Closed floor vent |
| Blank | Floor tile (or closed floor vent) |
| O | Air outlet |

In FIG. 1, each active rack has an outlet side and an inlet side, with most of the racks having an open vent adjacent the inlet side. The object identifier alone, i.e. R, S or P for an equipment rack, V for an open floor vent, C for a closed floor vent, and blank for a floor tile, may be sufficient to provide a degree of optimisation, given a current cooling underfloor airflow provided by one or more AHUs (not shown).

FIG. 2a illustrates examples of how scores can be applied to each cell in the grid depending on the object identifier for each cell. Each cell will affect the score of the cell itself and of surrounding adjacent cells. For each active equipment rack, identified as R or S, the cell 201 for the rack itself may add a score to a cell 202 adjacent the front, i.e. the air inlet face, of the rack, together with a score to each cell 203, 204 on either side, i.e. cells diagonally adjacent the air inlet face. In the example in FIG. 2a, a first rack 201 adds a positive score of 4 to the cell 202 adjacent the front of the rack 201 and a smaller positive score of 1 to each cell 203, 204 on either side. The higher positive score represents the cooling requirement of the rack 202, which partly extends to either side of the front of the rack 201. The cooling requirement for the rack can be met by providing one or more open vents adjacent the rack 201, which reduces the total score for the cells adjacent the rack 201. The orientation of the rack 201, i.e. which direction the inlet of the rack faces, affects how the adjacent cells are scored, as indicated by the different scores in the top two diagrams in FIG. 2.

For each cell with an open vent object identifier, identified as V, a score is applied to the cell covering the vent 205 and to cells 206, 207, 208, 209 surrounding the vent 205, as also illustrated in FIG. 2. In the illustrated example, the adjacent cells 206-209 are laterally adjacent to the vent cell 205. The vent cell is assigned a score of −5, while the adjacent cells 206-209 are assigned a score of −1. The result of this is that a vent cell placed immediately adjacent an active rack cell will cancel out the positive score provided by the rack.

An example of a total score calculation is also illustrated in FIG. 2a, where the vent cell V and two active equipment rack cells R1, R2 are provided, each rack having an inlet on the left side, thereby contributing a score of +4 to the cell laterally adjacent the air inlet side and +1 to cells diagonally adjacent the air inlet side. The total score for each floor tile or vent cell is calculated by adding the contributions from the vent cell and equipment rack cells. The total score for each cell can then be compared to upper and lower score thresholds to provide an indication of which cells may need to be changed, for example whether an open vent cell can be closed or removed or a closed vent cell or floor tile can be opened or replaced with an open vent.

FIG. 2b illustrates how a grid cell is provided with an equipment rack object identifier, given that the actual shape and size of the equipment rack 210 may be different to the shape and size of each cell, each cell typically corresponding to the shape and size of a single floor tile, which is typically square and of dimensions of around 600 mm×600 mm (around 2 ft×2 ft). An example rule illustrated in FIG. 2b is that a point 211 a set distance (e.g. 20 cm) behind the front air inlet face 212 of the rack 210 defines the object identifier of the cell. The corresponding scores for adjacent cells are indicated in the different positions for the rack 210 shown in FIG. 2b.

Table 2 below provides a summary of object identifiers and scores assigned to the cell and adjacent cells. In a simplified model, standard equipment racks, whether active or passive, open vents and blank floor tiles may be used. In a more complex model, partially active equipment racks and partially open vents may also be used, with scores adjusted accordingly.

TABLE 2
Object identifiers and corresponding values or scores

| | | Value on | Value on | |
|---|---|---|---|---|
| Object | Value | laterally | diagonally | |
| Identifier | on cell | adjacent cell | adjacent cell | Notes |
| Standard | 0 (N/A) | +4 | +1 | Racks require airflow from directly |
| Racks & | | | | in front but will benefit from |
| Switches | | | | airflow to the left and right tiles on |
| | | | | the diagonal. |
| Passive | 0 (N/A) | +0 | +0 | Passive racks do not require |
| Racks | | | | airflow. |
| Semi- | 0 (N/A) | +1 | +1 | Some equipment may be labelled as |
| passive | | | | semi-passive, requiring minimal |
| equipment | | | | airflow, which would be judged |
| | | | | purely on temperature rather than |
| | | | | the existence of vents |
| High | 0 (N/A) | +5 | +2 | Some equipment may be labelled |
| density | | | | high density, requiring maximal |
| racks | | | | airflow and may require a higher |
| | | | | concentration of floorvents |
| | | | | dependent on inlet temperature. |
| Vents | −5 | −1 | 0 | Vents can support racks directly |
| (open) | | | | adjacent to them, and partially |
| | | | | support racks at diagonals to them. |
| Vents | −2 | −1 | 0 | Partially open vents provide less |
| (partial) | | | | airflow. |
| Vents | −1 | 0 | 0 | Fully or nearly closed vents may |
| (closed) | | | | provide a small amount of airflow |
| | | | | at the cell position. |
| Floor tiles | 0 | 0 | 0 | Floor tiles do not contribute to |
| | | | | airflow. |

FIG. 3 illustrates the grid 100 of FIG. 1 with a total score for each vent and floor tile cell calculated and displayed on the grid. For a first group of vents 101, also indicated in FIG. 1, the total scores are −6, −7 or −8, indicating that these vents are providing an excess of cooling air that is not being countered by corresponding active equipment racks. This is evident from the arrangement of vents in FIG. 1, which have no adjacent equipment racks. The scores, which are all below a lower score threshold of −3, indicate that these cells should be identified for being changed, in this case to be either closed or switched for blank floor tiles. A second group of vents at 102 also show a total score below the lower threshold, in this case at −6, indicating that these vents 102 could also be changed by being closed or switched with blank floor tiles. There are further groups of vents at 103, 104, 105 which show a total score below the lower threshold, in each case scoring −5, indicating that these cells could be identified for being changed. Other cells 106, 107 score −4, again below the lower threshold and can be identified for removal.

Also illustrated in FIG. 3 are floor tile cells 108, 109, 110, 111, 112, 113 having scores above an upper threshold, in this case above an upper threshold of +4, which may be identified for being changed by adding a vent.

Following identification of cells having scores above an upper threshold or below a lower threshold, a user can be provided with a recommendation for such cells to be changed. The user can then act on these recommendations and update the model. The model can then be run again to identify any cells with scores indicating a need for further change. The model may be repeated until all cells have a score between the upper and lower thresholds.

Table 3 below provides a summary of indications to be made solely according to scores for each cell. Above the upper score threshold of +4 and below the lower score threshold of −3, all cells having such scores can be indicated for being changed, provided no other conditions apply (discussed below). Between these thresholds, cells can in some cases be indicated for being changed, for example if an adjacent rack is showing a high or low measured temperature, but a general rule is that cells adjacent to each other must not be changed together, since this is likely to have a more significant effect on surrounding cells so any changes to these cells should be carried out on a cell-by-cell basis.

TABLE 3
Indications based on cell total score

| Cell total score | Actions |
|---|---|
| >+4 | All cells indicated for being changed |
| −2 to +3 | Multiple cells can be indicated, but must not be adjacent |
| <−3 | All cells indicated for being changed |

The procedure for implementing changes given a number of identified cells may involve a series of steps, with certain identified cells being identified for changes before others in a systematic sequence of operations. An example sequence of operations is set out in Table 4 below.

TABLE 4
Example sequence of operations for removing and adding vents.

| Step | Action | Reason | Notes/Options |
|---|---|---|---|
| 1 | Remove all floorvents | These indicate vents that are | This step can be looped with the |
| | with airflow score < −3, | not providing airflow in the | lowest score cells, recalculating |
| | provided that the local | correct place | and then repeating until all cells |
| | temperature is below the | | have a score of > −4: |
| | threshold | | |
| 2 | For each cell with airflow | This ensures that floorvents | Removing vents takes place |
| | score > +4 add a vent if | are placed in the most | before adding vents to: i) |
| | an adjacent rack | appropriate locations but | build up underfloor pressure, |
| | temperature is above a | should only be added where | improving airflow; and ii) |
| | defined threshold | cooling is required. | providing spare vents to add. |
| 3 | Remove/close all vents | These indicate vents that are | |
| | with airflow score = −3 | likely to be providing too | |
| | and rack temperature is | much airflow given the | |
| | below a defined | distribution of equipment in | |
| | threshold | the vicinity | |
| 4 | Remove/close all vents | These indicate vents that are | All temperatures below a lower |
| | with airflow score = −2 | likely to be providing too | defined threshold are handled |
| | and rack temperatures | much airflow given the | first. Once these are resolved, |
| | are below defined | distribution of equipment in | then a new tasklist is generated |
| | thresholds | the vicinity. | for the upper defined threshold. |
| 5 | Add/open all vents with | These indicate areas where | |
| | airflow score = 4 where | floorvents are highly | |
| | rack temperature is | recommended given the | |
| | above the conditional | distribution of equipment in | |
| | | the vicinity. | |
| 6 | For all gridsquares with | This is a calibration step | There may be additional reasons |
| | value = −1, recommend | which requires the | for adding a vent (e.g. power at |
| | close/remove floorvent if | temperature of the rack to | rack level, criticality of rack etc.) |
| | local temperature is less | suggest a change. | |
| | than the conditional | | |
| 7 | For all gridsquares with | This is a calibration step | As for step 6, There may be |
| | value = 3, recommend | which requires the | additional reasons why to add a |
| | open/add floorvent if | temperature of the rack to | floorvent (power at rack level, |
| | local temperature is | suggest a change. | criticality of rack) |
| | greater than the | | |
| | conditional | | |

The above example sequence of operations may be expressed as a series of rules to be used in an optimisation algorithm, as set out in Table 5 below, in which Tₘₐₓ is an upper temperature threshold (which may be between 20 and 32° C., for example 27° C.), Tₘᵢₙ is a lower temperature threshold (which may be between 15 and 25° C., for example 18+C), a difference between Tₘₐₓ and Tₘᵢₙ being at least 4° C.

TABLE 5
Example rules for making changes dependent on cell score.

| Score | Principle Action | Conditions | Defined Threshold | Notes |
|---|---|---|---|---|
| >4 | Add vent | Action unless local | T_{local} > Tₘᵢₙ + | Add all tiles |
| | | rack temperature is | (Tₘₐₓ − Tₘᵢₙ)/4 | |
| | | too low | | |
| 4 | Open/add vent | Action unless local | T_{local} > Tₘᵢₙ + | Maximum of |
| | | rack temperature is | 2*(Tₘₐₓ − Tₘᵢₙ)/3 | e.g. 6 tiles |
| | | too low | | |
| 3 | Open/add vent | Action unless local | T_{local} > Tₘᵢₙ + | Maximum of |
| | | rack temperature is | 2*(Tₘₐₓ − Tₘᵢₙ)/3 | e.g. 3 tiles |
| | | too low | | |
| 2 | No action | | | |
| 1 | No action | | | |
| 0 | No action | | | |
| −1 | Close/remove | Action unless local | T_{local} < Tₘᵢₙ + | Maximum |
| | vent | rack temperature is | (Tₘₐₓ − Tₘᵢₙ)/4 | of, e.g. 3 |
| | | too high | | |
| −2 | Close/remove | Action unless local | T_{local} < Tₘᵢₙ + | Maximum |
| | vent | rack temperature is | (Tₘₐₓ − Tₘᵢₙ)/4 | of, e.g. 6 |
| | | too high | | |
| −3 | Remove vent | Action unless local | T_{local} < Tₘₐₓ − | Maximum |
| | | rack temperature is | (Tₘₐₓ − Tₘᵢₙ)/4 | of, e.g. 6 |
| | | too high | | |
| <−3 | Remove vent | Action unless local | T_{local} < Tₘₐₓ − | Remove all |
| | | rack temperature is | (Tₘₐₓ − Tₘᵢₙ)/4 | tiles |
| | | too high | | |

The scores used in the above examples are to illustrate how a scoring system may operate. Other scores may be used depending on specific requirements. One possible alternative may be to score an open vent at +4 instead of +5, in which case the above rules for making changes would change, with thresholds for adding or removing a vent adjusted accordingly. Using larger positive and negative scores for vents and active equipment racks may have the advantage of providing a larger ‘safe range’ between the upper and lower score thresholds. With the positive and negative scores for racks and vents being balanced, the ideal score for any vent will tend to be +1.

FIG. 4 is a flowchart illustrating a simplified process for identifying and implementing modifications in a data centre to optimise air flow cooling. In a first step 401 a model of the data centre is provided, representing the data centre as a grid. In a second step 402, a score is assigned to each cell, for example according to the rules described above. A total score is calculated at step 403 for each cell having a floor tile or open vent object identifier. A check is then made for each cell, starting or continuing at step 404 for the first or next cell. If the cell is a vent cell (step 405), and the score for the cell is below the lower threshold (step 406), the cell is recommended for closing (step 407). Otherwise, the process continues to the next cell, if any cells remain (step 411). If the cell is a floor tile (or closed vent) cell (step 408), and the score for the cell is above the upper threshold (step 409), the cell is recommended for opening (step 410). Once all cells have been analysed (step 411), a visual output is provided with any recommendations (step 412) arising from steps 407, 410.

After providing the visual output with recommendations, the user may implement some or all of the recommendations and provide an input to the model to amend the identifier of cells that have been changed. The method may then be repeated, which may result in further recommendations, which the user may then implement or reject. The process may repeat until all cells have a score between the upper and lower thresholds, discounting any cells that have been selected by the user for not being changed despite a recommendation.

In a further refinement of the above process, cells having a score between the upper and lower thresholds may also be identified for changing on condition of an adjacent equipment rack having a particular temperature relative to an upper or lower threshold temperature. A recommendation for a cell to be opened or a vent added may be made if an adjacent equipment rack cell has a temperature above an upper threshold temperature. A recommendation for a cell to be closed or changed to a floor tile may be closed or replaced may be made if an adjacent equipment rack cell has a temperature below a lower threshold temperature.

FIG. 5 is a screenshot of a graphical user interface (GUI) 500 for presenting an output of the above model. The GUI provides a plan view visual representation of the data centre in the form of a grid 501, indicating the location of equipment racks 502 and vents 503. Each equipment rack 502 is shown with a colour coding indicating a measured temperature of the rack. Following the process described above, a number of recommendations 504 are made, in this cases each recommendation indicating that a particular vent should be replaced by a solid floor tile.

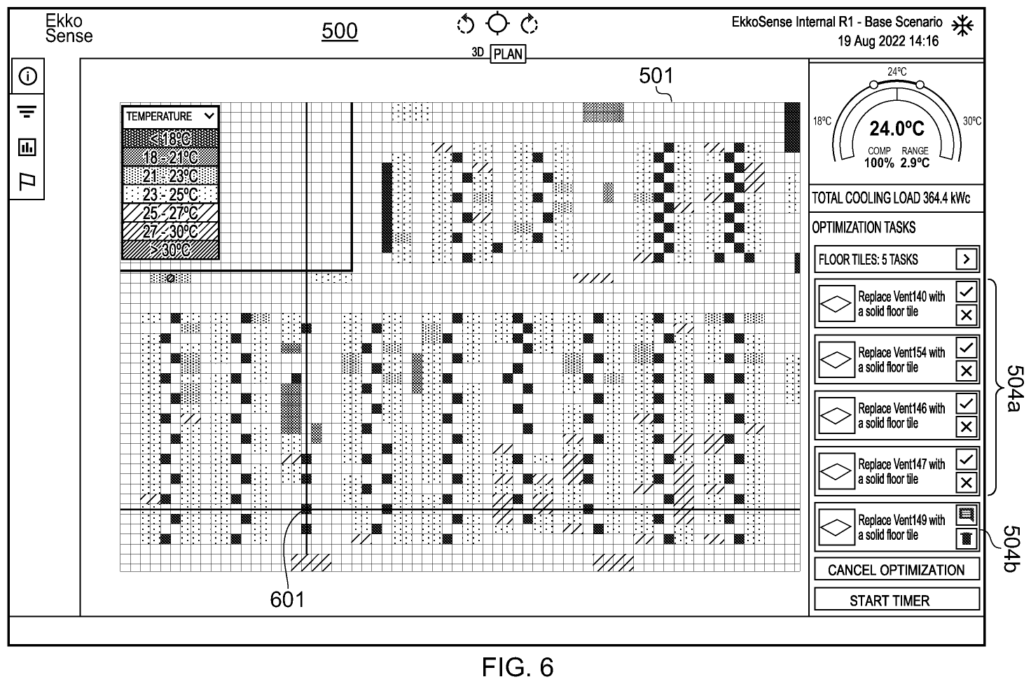

FIG. 6 is another screenshot of the GUI 500 after the user selects four of the recommendations 504a for implementing and selects one of the recommendations 504b to be rejected. One of the recommendations is selected to identify the corresponding vent 601 on the grid 501. A recommendation being rejected by the user will result in the model being updated to exclude the corresponding cell being identified in a subsequent round of optimization.

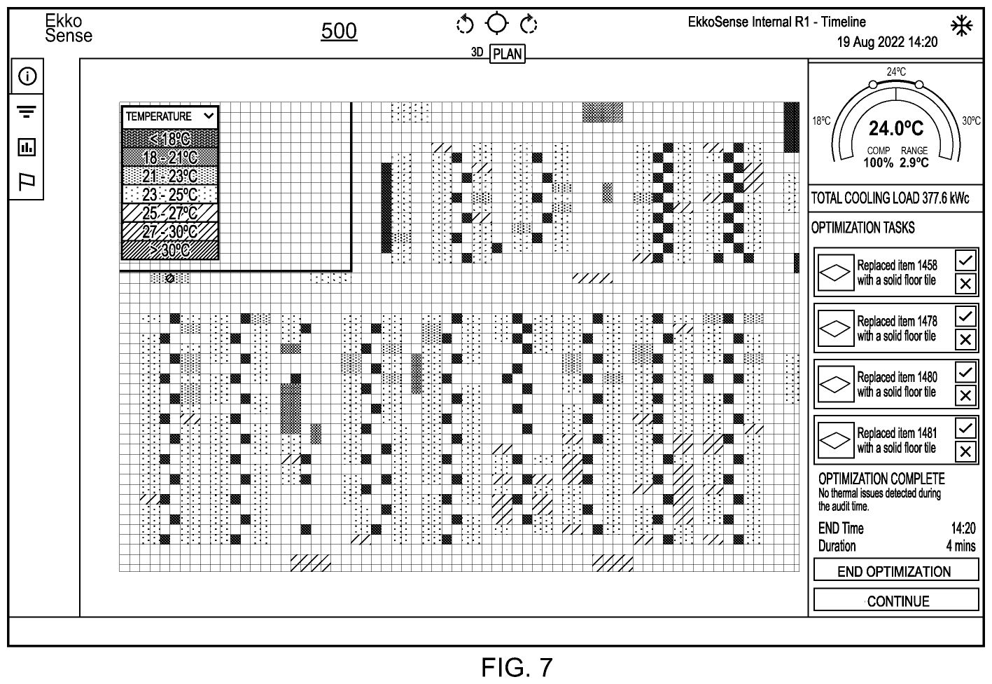

FIG. 7 is a further screenshot of the GUI 500 following completion of an optimization process after which the user updates the model to correspond with changes made to the data centre. At this point no further recommendations are provided. The user may then end the optimization routine and restart with the amendments to the model, which may then result in further recommendations.

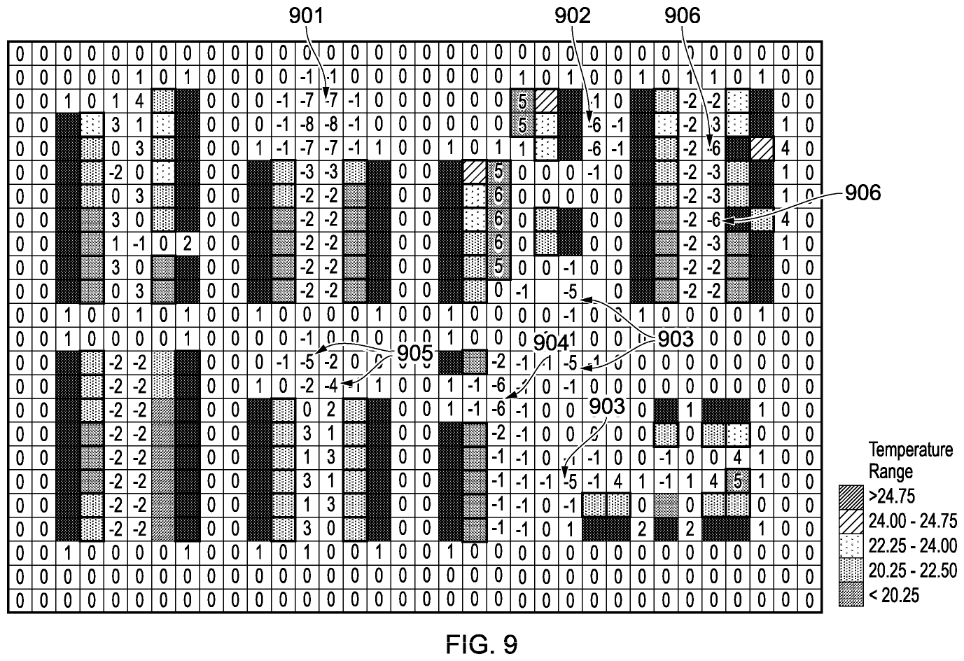

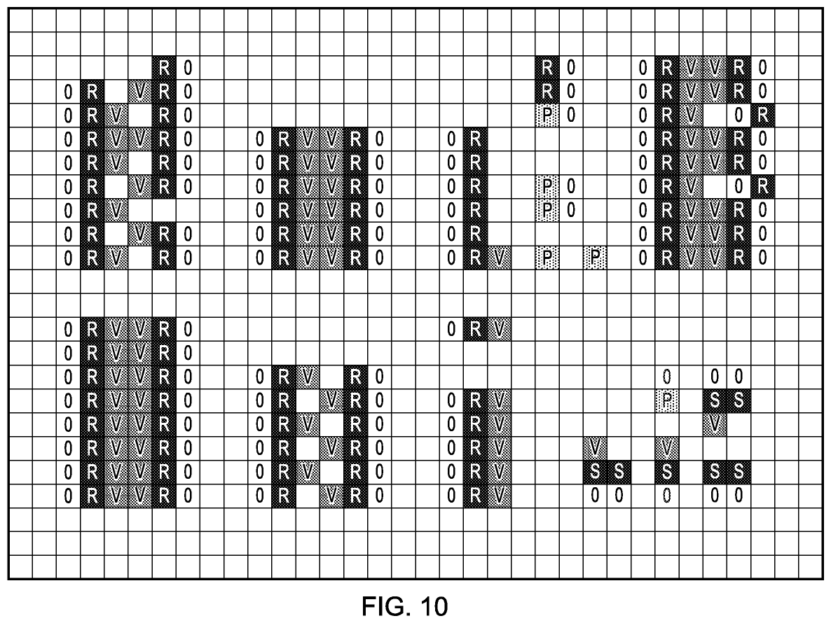

FIGS. 8 to 16 illustrate a sequence of steps in which an example grid-based model of a data centre is analysed and adjusted step by step. FIG. 8 illustrates the grid 800 prior to any analysis or adjustments, the grid comprising active equipment racks (R or S), passive equipment racks (P), vents (V) and outlets (O). FIG. 9 illustrates the grid after scores are assigned and calculated for each cell. The racks in FIG. 9 are also colour coded according to their measured temperature, which in this example is divided into five ranges: below 20.25° C., between 20.25 and 22.5° C., between 22.5 and 24° C., between 24 and 24.75° C. and above 24.75° C. These temperature ranges are selected according to the optimum cooling for a particular data centre and may vary depending on the application. In FIG. 9, various open vent cells or groups of cells 901, 902, 903, 904, 905, 906 are identified having scores below −3. These vents are recommended for being removed, provided a local temperature (e.g. the temperature or an adjacent rack) is below the upper temperature threshold, which in this case is the upper limit of 24.75° C. None of the adjacent equipment racks in this example are indicated as having a temperature above the upper threshold temperature, indicating that all the identified vents can be closed or replaced with floor tiles. The result of this is illustrated in FIG. 10, which shows the grid with these vents replaced with floor tiles.

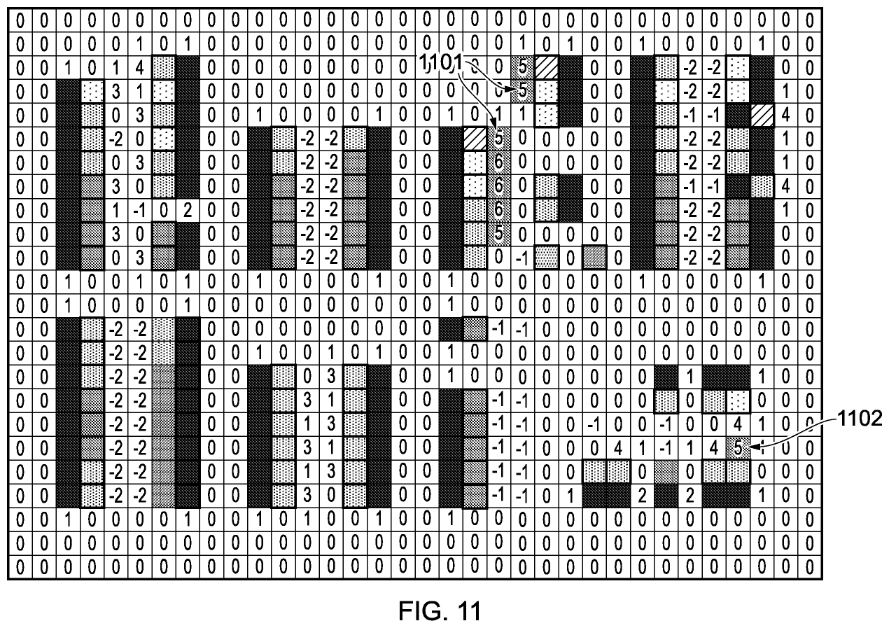

In a second step of the optimization process, illustrated in FIG. 11, floor tiles are identified having a score above+4 and where a local equipment rack temperature is above a first lower temperature threshold, in this case above 20.25° C. These floor tiles or groups of floor tiles 1101, 1102 are identified for vents to be added. In this case, all the adjacent equipment racks meet the temperature criterion, so the recommendation is to replace the floor tiles 1101, 1102 with vents.

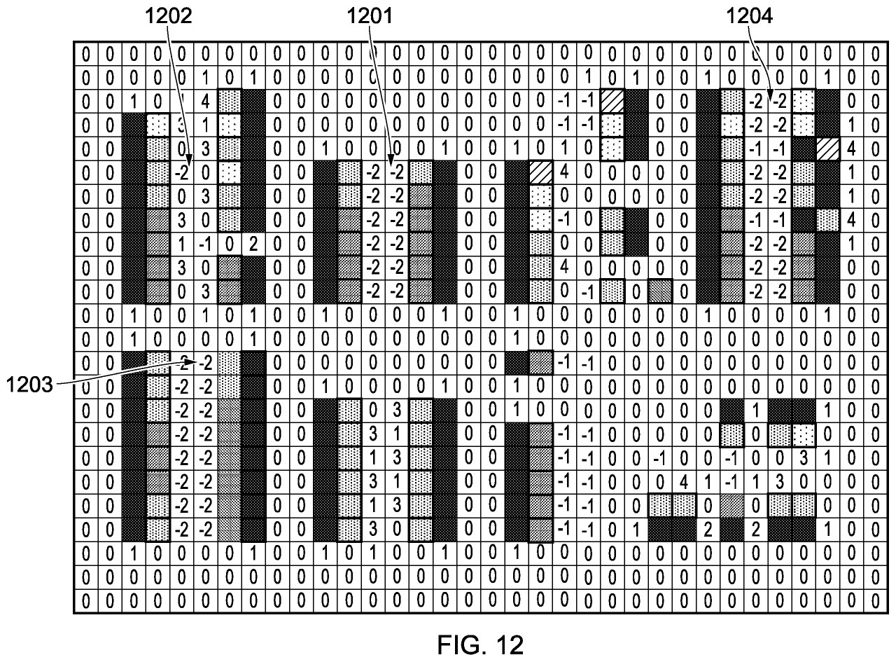

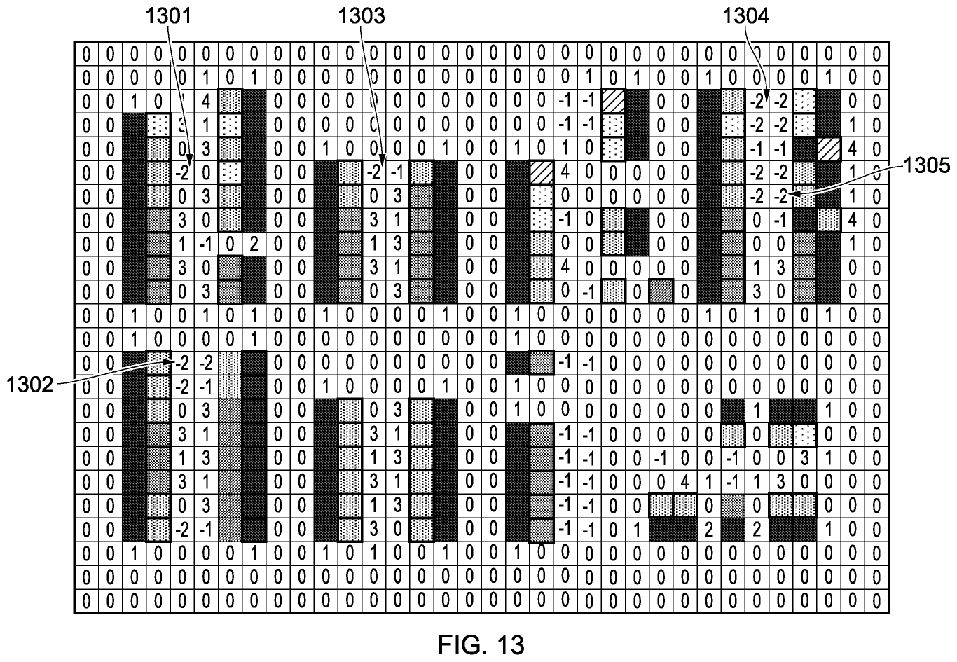

In a first part of a third step, illustrated in FIG. 12, cells 1201-1204 having vents with scores between the upper and lower thresholds, in this example scores of −2, are identified and recommended for removal where the local temperature is below a lower temperature threshold, for example below the first quartile of the example temperature scale, in this case below 20.25° C. This may be extended further in a second part of the third step, illustrated in FIG. 13, by identifying and removing vents where cells 1301-1305 score −2 and the local temperature is below a second lower temperature threshold, in this case below 22.5° C.

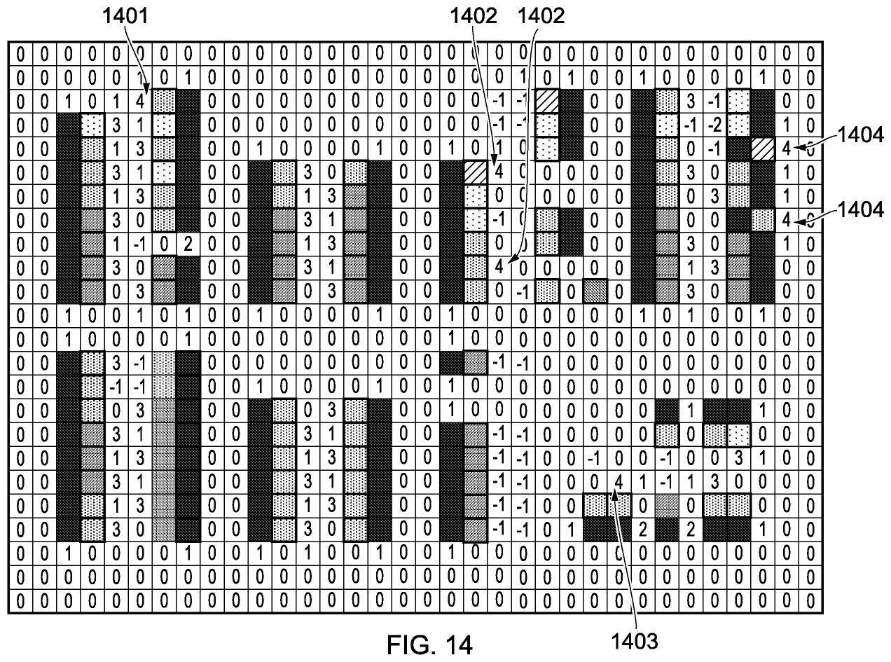

In a fourth step, illustrated in FIG. 14, vents may be added where scores for cells 1401-1404 are between the upper and lower thresholds, in this example at +4, and where the local temperature is above an upper temperature threshold, for example above 24° C.

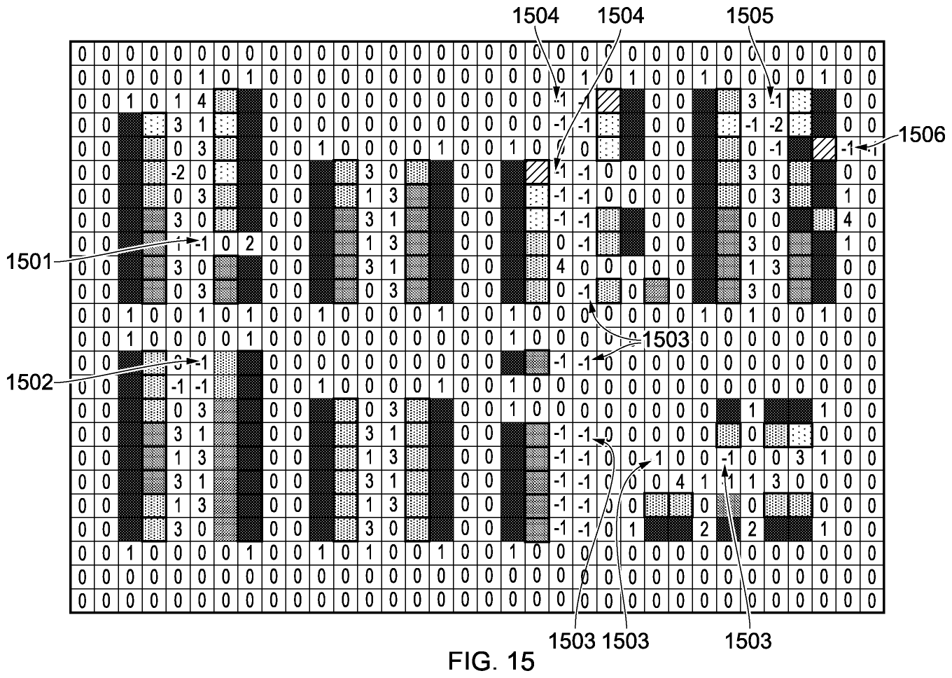

In a fifth step, illustrated in FIG. 15, vents may be closed or removed where scores for cells 1501-1506 are −1 and where a local temperature is below the first lower temperature threshold (20.25° C. in this example), followed by removal or closure of vents where cell scores are −1 and the local temperature is below the second lower temperature threshold (22.5° C.), corresponding to a midpoint temperature.

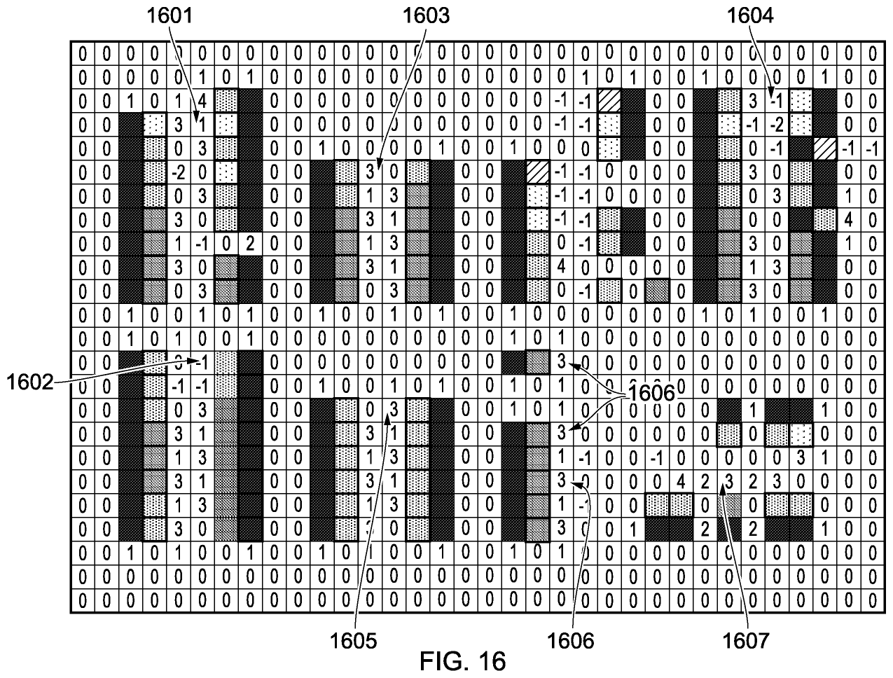

Finally, in a sixth step, illustrated in FIG. 16, vents may be added or opened where scores for cells 1601-1607 are +3 and where a local temperature is above a higher temperature threshold, in this example 24° C., corresponding to a two-thirds point temperature over the temperature range of interest.

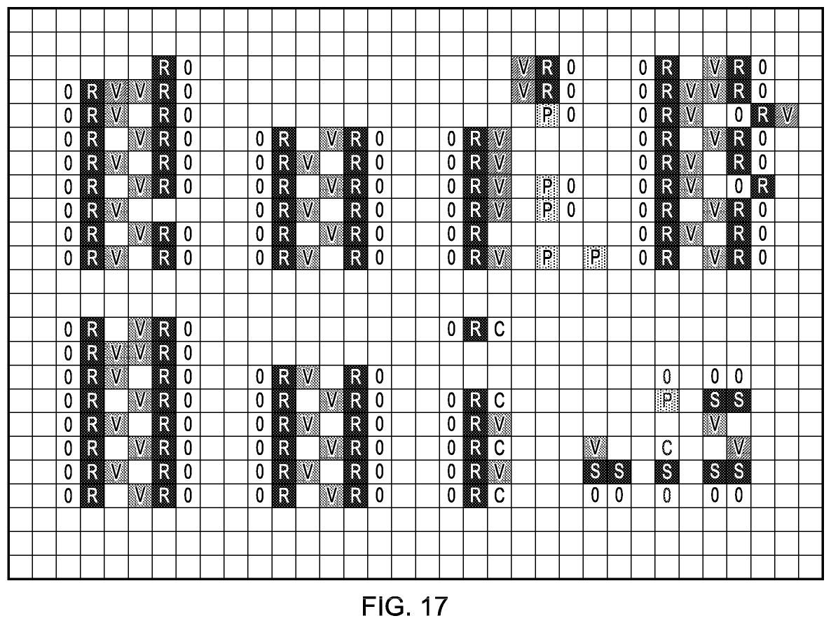

Once all steps are completed, the final form of the grid is as illustrated in FIG. 17. The airflow cooling is now optimised compared to the arrangement at the outset in FIG. 10. Cells indicated with a “C” marker correspond to vents that have been closed rather than removed and replaced with floor tiles.

Other embodiments are intentionally within the scope of the invention as defined by the appended claims.

1. A computer-implemented method for identifying modifications in a data center to optimize air flow cooling, the data center having rows of equipment racks separated by passages, cooling airflow within the data center provided from one or more air handling units providing a flow of cooling air to the equipment racks via underfloor passages and floor vents, the method comprising:
i) providing a floor plan model of the data center represented as a grid comprising a plurality of cells, each cell having an object identifier, the object identifier selected from a plurality of objects including a floor tile, an open vent and an equipment rack;
ii) assigning a score to each cell and to cells adjacent to each cell based on the cell's object identifier;
iii) calculating a total score for each cell having a floor tile or open vent object identifier;
iv) identifying whether a cell having an open vent object identifier has a total score below a lower score threshold;
v) identifying whether a cell having a floor tile object identifier has a score above an upper score threshold; and
vi) providing as a visual output to a user of the model an indication on the grid of any cells identified in iv) and v) together with a recommendation for cells to be changed.

2. The method of claim 1, wherein the recommendation for a cell identified in iv) is for the open vent to be changed by removing or closing the open vent.

3. The method of claim 1, wherein the recommendation for a cell identified in v) is for the floor tile to be changed to an open vent.

4. The method of claim 1, comprising:
vii) receiving a user input amending the object identifier of one or more cells identified in iv) or v).

5. The method of claim 4, further comprising repeating ii) to vi).

6. The method of claim 5, further comprising, prior to repeating ii) to vi), receiving a user input rejecting a recommendation relating to a cell and updating the model to exclude the cell from being identified when repeating ii) to vi).

7. The method of claim 5, further comprising repeating ii) to vii) until all cells have a score between the upper and lower score thresholds.

8. The method of claim 1, wherein cells adjacent to each cell include cells laterally adjacent and diagonally adjacent to each cell.

9. The method of claim 1, wherein each cell having an equipment rack object identifier has an orientation indicating an air inlet side of the equipment rack, ii) including assigning a positive score to a cell adjacent the air inlet side.

10. The method of claim 9, wherein ii) includes assigning a smaller positive score to cells diagonally adjacent the air inlet side.

11. The method of claim 1, wherein for each cell having an open vent object identifier, ii) includes assigning a negative score to the cell and a smaller negative score to laterally adjacent cells.

12. The method of claim 1, wherein iv) and v) exclude any cells adjacent to an identified cell from being identified.

13. The method of claim 12, wherein iv) and v) are carried out on alternate cells in the grid.

14. The method of claim 1, wherein calculating the total score for each cell comprises adding a score for the cell to a score for the cell provided by adjacent cells.

15. The method of claim 1, wherein each cell having an equipment rack object identifier has an associated recorded temperature.

16. The method of claim 15, further comprising:
vii) identifying whether a cell having a floor tile object identifier has a score between the upper and lower score thresholds and whether an adjacent cell having an equipment rack has an associated recorded temperature above an upper threshold temperature; and
viii) providing as a visual output to the user of the model an indication on the grid of any cells identified in vii) together with a recommendation to open or add a vent at each identified cell.

17. The method of claim 15, further comprising:
vii) identifying whether a cell having a floor tile object identifier has a score between the upper and lower score thresholds and whether an adjacent cell having an equipment rack has an associated recorded temperature below an lower threshold temperature; and
viii) providing as a visual output to the user of the model an indication on the grid of any cells identified in vi) together with a recommendation to close or remove a vent at each identified cell.

18. A computer program comprising instructions that, when executed, cause a computer to perform the method according to claim 1.
